(19) United States
(12) Patent Application Publication
(10) Pub. No.: US 2009/0009815 A1
(43) Pub. Date: Jan. 8, 2009

(54) APPARATUS FOR ELECTRONIC STORAGE OF RECIPES

(76) Inventors: Gregory Karasik, Bellevue, OH (US); Denao V. Ruttino, Bellevue, OH (US); Greg L. Pelts, Santa Clara, CA (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/168,415

(22) Filed: Jul. 7, 2008

Related U.S. Application Data
(60) Provisional application No. 60/948,063, filed on Jul. 5, 2007.

(51) Int. Cl. H04N 1/00; G06F 3/048; G06F 17/30; G06F 7/10; G06F 13/36; G06F 13/42

(52) U.S. Cl. 358/403; 715/853; 715/780; 707/104.1; 707/3; 710/303; 707/E17.016; 707/E17.008

(57) ABSTRACT

A recipe storage device provides a simple user interface for scanning or inputting recipes for storage and retrieving and displaying the stored recipes. The stored recipes can be searched based on an associated category or on search terms found in the recipe.

### RELATED APPLICATION DATA

This application claims the benefit of U.S. Provisional Application No. 60/948,063, filed Jul. 5, 2007, which is incorporated by reference.

### TECHNICAL FIELD

The invention pertains generally to the field of data storage and retrieval devices and, more particularly, to a portable electronic recipe storage device for storage and retrieval of recipes and the like.

### BACKGROUND

Many cooking enthusiasts retain a great number of recipes that have been drawn from numerous sources. The recipes can be clipped from magazines or copied onto recipe cards. Recipes are also available from electronic sources such as CD-ROM or recipe websites and such recipes are often printed out and stored with the clipped recipes and recipe cards. Locating a particular recipe can be time consuming and frustrating when the recipes are not centrally located or organized according to some criteria.

Recipe storage programs for personal computers and recipe websites are aimed at solving the recipe organization problem. While these programs and websites may allow a user to construct a central electronic repository for recipes and also allow a user to search for recipes based on ingredients or categories, the programs and websites usually require the use of a personal computer, an item most cooks do not have in their kitchen. Many of the programs or websites can be accessed using some other multi-purpose computing device such as a personal digital assistant (PDA); however, many cooks may not have the desire or ability to operate such a device simply to store their recipes. Further, many of the programs and websites require a user to type in the recipe so that it can be stored in a database and later searched based on words in the recipe.

### SUMMARY

An apparatus for electronic storage of recipes, also referred to herein as a portable electronic recipe storage device, provides a simple interface for scanning and storing lists, such as, for example, recipes, that a user possesses in printed form. The recipes may also be input from electronic sources. The recipes may be input to a recipe processing component that generates a searchable version of the recipe that can be searched by keyword, keyword or otherwise.

One or more categories may be associated by the user with each stored recipe. Recipe records include the original recipe in its original format, a searchable version that can be searched by keyword, and categories that have been associated with the recipe by the user. The recipes may then be searched by category or keyword. The selected recipe may be displayed in its original format, such as handwritten script or magazine print, or in a standardized format created by the recipe processing component. A series of simple touch screen displays guide a user through the recipe input and search/retrieval functions.

One aspect of the invention relates to a portable electronic recipe storage device comprising: a housing suitable to be supported in an associated user's hand; a display secured at least partially within the housing, wherein the display presents recipe information to the associated user in a graphical user interface; a scanner secured to the housing, wherein the scanner receives recipe information from a medium; a memory for storing the recipe information; a microprocessor coupled to the display, the scanner and the memory, wherein the microprocessor is configured to receive recipe information from the scanner, store the recipe information in the memory and display the recipe information to the associate user; and a battery secured in the housing for providing power to the device.

Another aspect of the invention relates to a method for storing recipe information, the method comprising: scanning a medium containing a recipe; storing the recipe in a memory, wherein the recipe is stored in an original form and in a text searchable form; querying an associated user through a graphical user interface on a display to assign a recipe name to the recipe; receiving a user input indicative of a response to the query, wherein the user input includes the unique recipe name; and assigning the unique name to the recipe.

Another aspect of the invention relates to a method for retrieving recipe information, the method comprising: displaying a plurality of icons on a graphical user interface, wherein each of the plurality of icons is associated with a unique function; receiving an indication from an associated user of a desire to retrieve recipe information; querying the associated user to enter a target recipe to be found in a database of recipes; searching the database of recipes to find the target recipe; and displaying the target recipe in a first form, wherein the first form is a scanned form of the original recipe.

Another aspect of the invention relates to a recipe storage and retrieval system, the system comprising: the portable electronic recipe storage device as described above; and a docking station having at least engagement surface for holding the portable electronic recipe storage device, wherein the docking station includes a communication port for exchanging communication signals between the portable electronic recipe storage unit and an associated computer; and the docking station includes a scanner housed at least partially within the docking station.

Further features and advantages of the invention will become apparent from the following detailed description made with reference to the accompanying drawings.

### BRIEF DESCRIPTION OF THE DRAWINGS

In the accompanying drawings, which are incorporated in and constitute a part of this specification, embodiments of the invention are illustrated, which together with the description of the invention serve to illustrate the principles of this invention. The drawings and detailed description are not intended to and do not limit the scope of the invention or any subsequent claims in any way. Instead, the drawings and description only describe embodiments of the invention and other embodiments of the invention not described are encompassed by this disclosure of the invention.

FIG. 1 is a schematic front view of an exemplary recipe storage device constructed in accordance with the present invention.

FIGS. 1A and 1B are schematic side views of the recipe storage device of FIG. 1.

FIG. 2 is a schematic front view of the recipe storage device of FIG. 1 displaying a recipe selection screen.

FIG. 3 is a schematic front view of the recipe storage device of FIG. 1 displaying a recipe display screen.

FIG. 4 is a schematic front view of the recipe storage device of FIG. 1 displaying a recipe search screen.

FIG. 5 is a schematic front view of the recipe storage device of FIG. 1 displaying a recipe title input screen.

FIG. 6 is a schematic front view of the recipe storage device of FIG. 1 displaying a recipe category input screen.

FIG. 7 is a schematic front view of the recipe storage device of FIG. 1 displaying a recipe input type selection screen.

FIG. 8 is a block diagram illustrating various functional components of the recipe storage device of FIG. 1.

FIG. 9 is a schematic view of a data table that may be used to organize recipe data in the recipe storage device of FIG. 1.

FIGS. 10A-10B are a flowchart depicting a method for storing, searching, retrieving, and displaying recipes using the recipe storage device of FIG. 1.

FIG. 11 is schematic front view of a recipe storage device displaying a “Home” screen.

FIG. 12 is schematic front view of a recipe storage device displaying a “Browse Recipe” screen.

FIGS. 13-17 are schematic front view of a recipe storage device displaying a “New Recipe” screen.

FIGS. 18-19 are schematic front perspective and side elevational views, respectively, of another exemplary recipe storage device coupled to a docking station.

FIG. 20 is a system including a recipe storage device and a computer such as a personal computer.

### DETAILED DESCRIPTION

The Detailed Description of the Invention merely describes preferred embodiments of the invention and is not intended to limit the scope of the specification or any issued claims in any way. Indeed, the invention as described is broader than and unlimited by the disclosed embodiments, and the terms in the specification have their full ordinary meaning, unless otherwise indicated.

In the following description, the term “recipe” will be used chiefly in a culinary context. However, it is to be understood that the term “recipe” includes any list of instructions and can be advantageously stored in a portable handheld electronic device for easy access. For example, in a medical context, the recipe may be a set of instructions for a given surgery. These recipes are often kept by a surgeon on index cards. The surgical recipe may include a recommended order of surgical steps, lists of surgical devices needed for the procedure, and a preferred set up for the operating room. Any number of documents that are traditionally kept on cards and/or paper can therefore be construed as falling within the definition of recipe. As another example, in a mechanic's context, the recipe may be a set of instructions for a given vehicular procedure (e.g., changing brake pads, troubleshooting engine problems, etc.). In yet another example, in an athletic context, the recipe may be a set of instructions for a given play, a golf shot, a training program, etc.

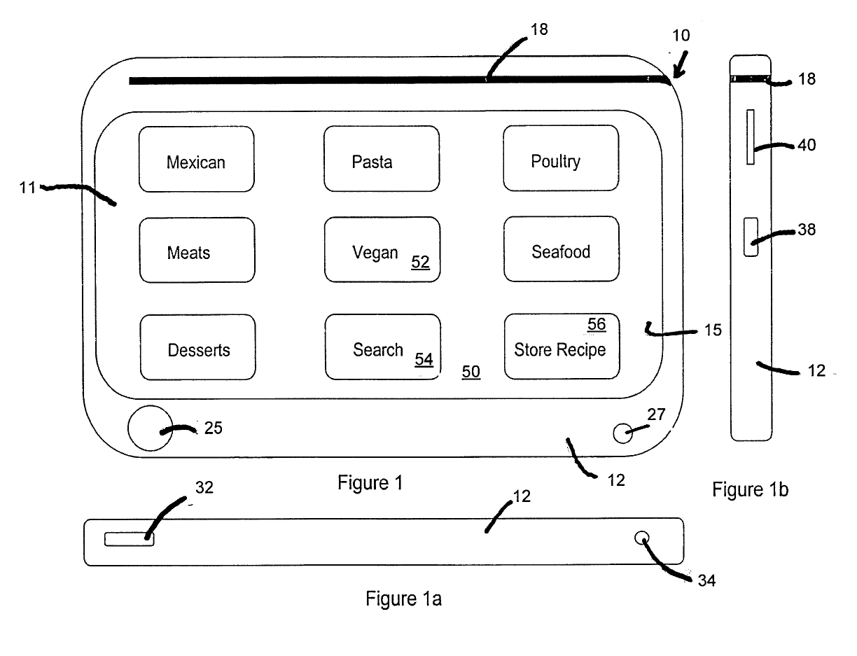

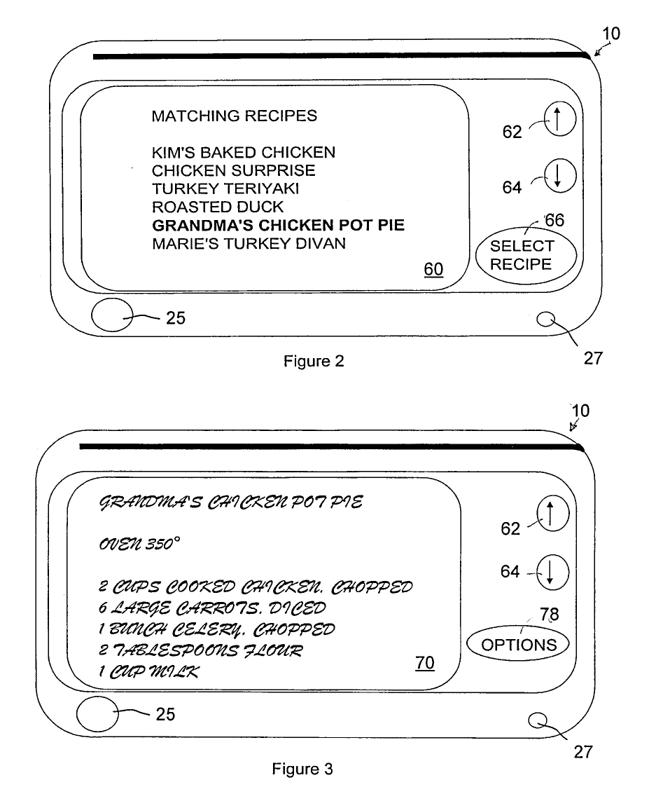

Referring to FIG. 1, an exemplary portable recipe storage device according to the invention is shown at 10. The recipe storage device 10 includes a housing 11, which is portable and formed to be comfortably held in a user's hand, and a display 15, which preferably is a touch screen display. The portable electronic recipe storage device 10 is designed to be light weight and easily held by a user in a single hand. Preferably, the device 10 weighs less than 5 pounds. More preferably, the device 10 weighs less than 3 pounds. In one embodiment, the device 10 includes a securing means on the back of the device to secure the device to a structure (e.g., an appliance). The securing means may be any desirable means for securing the device to the structure. For example, the securing means may be a magnet, Velcro, suction cups, clips, etc.

A power button 25 and an optional reset button 27 are provided in the housing 11 and are mechanically actuable. Of course, other buttons may be present in the housing for other purposes. On its bottom, the recipe storage device 10 may include an optional USB port 32 that can accept a USB cable or connect to a docking station and an optional AC adapter 34. The USB port can be used to download recipes from a computer source, such as a website or as a means to charge rechargeable batteries (not shown) within the recipe storage device 10. In addition, the recipe storage device 10 may include wireless interface adapter to facilitate wireless communications with a wireless local area network, for example. Such wireless adapters may include, for examp, a WiFi adapter, a Bluetooth adapter, an infrared adapter, etc. As will be appreciated, other types of ports may be used alternatively and additionally to establish electronic communication with another electrical device.

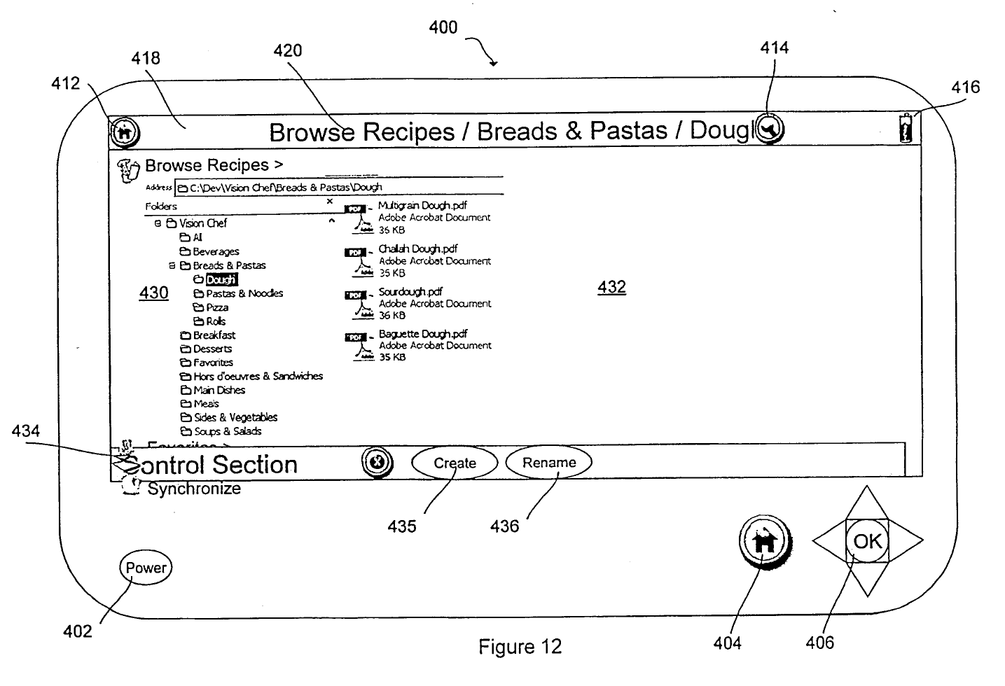

An optional SDRAM or memory stick port 40 is shown on the side of the recipe storage device 10 as well as an optional Infrared (IR) I/O interface 38, as shown in FIG. 1b. The IR interface 38 can be used to transfer recipes between recipe storage devices and/or other electronic devices that have an IR interface. A scanner slot 18 is present in a top portion of the recipe storage device 10. Paper recipes can be passed through this slot to be scanned by a scanner 180 (FIG. 8) and stored in the recipe storage device 10. In other embodiment, discussed below, a scanner may be present on a side of the of the recipe storage device 10. In yet another embodiment, the scanner may be encased in a docking station configured to accept the recipe storage device. Any suitable scanner may be used. Suitable scanners include, for example, a hand scanner, a bar scanner, a sheet-fed scanner, a flat bed scanner, etc. The scanner head is generally housed within the housing 11 when the scanner is a mechanical feed scanner. The housing 11 generally includes an opening for the scanner head to scan recipes when the scanner is a hand scanner or a bar scanner, for example.

The recipe storage device 10 may also include additional functional components. For example, the recipe storage device 10 may also include an MP3 player, a digital camera, a digital picture frame, an alarm clock, etc.

FIGS. 1-7 illustrate various graphical user interface screens that communicate options to the user and receive the user's selected option for processing. As discussed in detail below, the graphical user interface may display a single level of folders at a given time and/or multiple levels of folders may be displayed at a given time.

Referring to FIG. 1, a base screen 50 is displayed. The base screen 50 is the first screen shown when the portable electronic recipe storage device 10 is powered on and/or when the reset button 27 is actuated. The base screen 50 features a plurality of “soft” buttons 52, 54, 56 that are actuated by touching a corresponding face on the display. The size, location, appearance, and function for all soft buttons are determined by operating software and can be changed by modifying the software. In the particular embodiment shown in FIG. 1, the base screen 50 includes seven (7) category buttons 52 along with a “Search” button 54 and a “Store Recipe” button 56. The number and name of the various buttons and icons, and as well as any number of recipe storage device operating parameters, can be set by modifying on board software prior to retail. The recipe storage device 10 could also be programmed by a purchaser, possibly using a personal computer communication via the IR interface or USB input port.

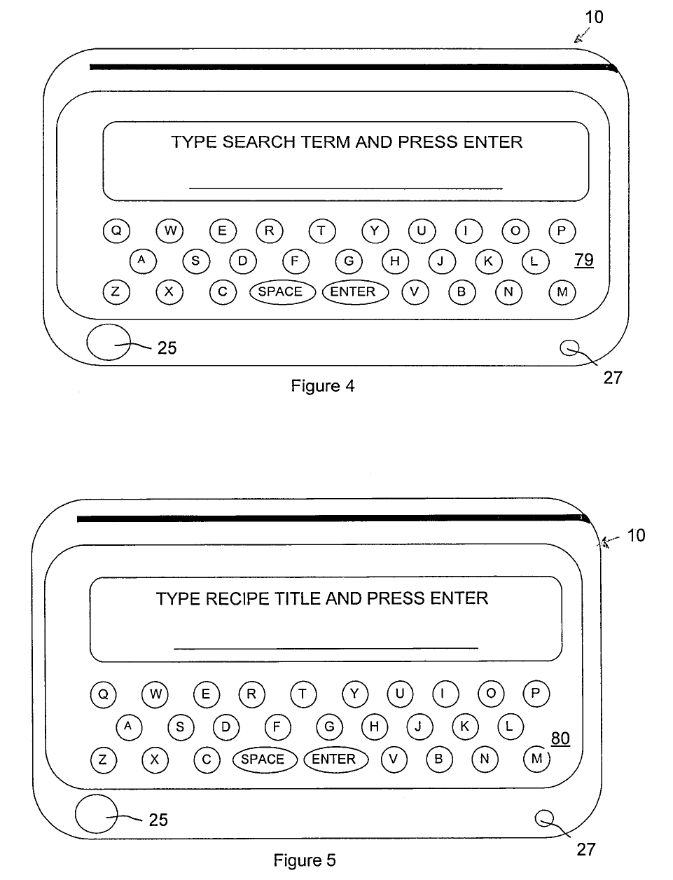

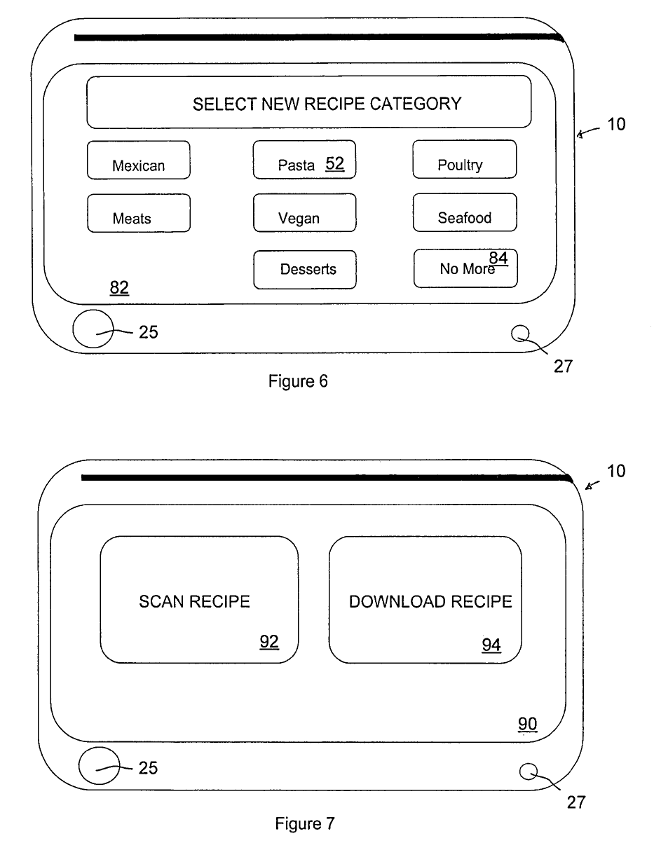

The user presses one of the category buttons to search a recipe database (FIG. 8) for all recipes that the user has associated with that category. To retrieve a list of all recipes that have been stored under that category, the user touches and releases the surface of the display 15 above the desired category button 52. FIG. 2 illustrates a recipe selection screen 60 that shows a list of the titles of all recipes that the user has stored under the selected category, in the illustrated case “Poultry.” Soft scroll buttons 62, 64, which could also be implemented as a user input device on the housing (e.g., mechanical switches in the housing, a cursor pad, etc.), allow the user to move up and down the list. The user may touch a select recipe button 66 to display the highlighted recipe, in this case “Grandma's Chicken Pot Pie.” In another embodiment, the user may touch an icon and/or text associated with the recipe. In FIG. 3, a recipe display screen 70 is shown. The recipe is displayed having the same appearance as when the recipe was scanned. For example, if the original recipe was in Grandma's handwriting on a decorated recipe card, that is how the recipe is displayed. In this manner, sentimental aspects of the recipe as well as any handwritten comments on the recipe can be preserved. In another embodiment, the recipe is displayed in a standardized format that is created by a recipe processing component, such as, for example, an OCR engine (FIG. 8) acting on the scanned version of the recipe. The scroll buttons 62, 64 are used to move the recipe up and down within the display 15. An optional “Options” button 78 may be used to select additional features of the recipe storage device 10. For example, a portioning program may be accessed that automatically scales the quantities of the ingredients based on an input desired number of servings. A nutritional analysis program may be accessed to calculate the nutritional values for the recipe. The user may also use the “Options” button to enter comments about the recipe.

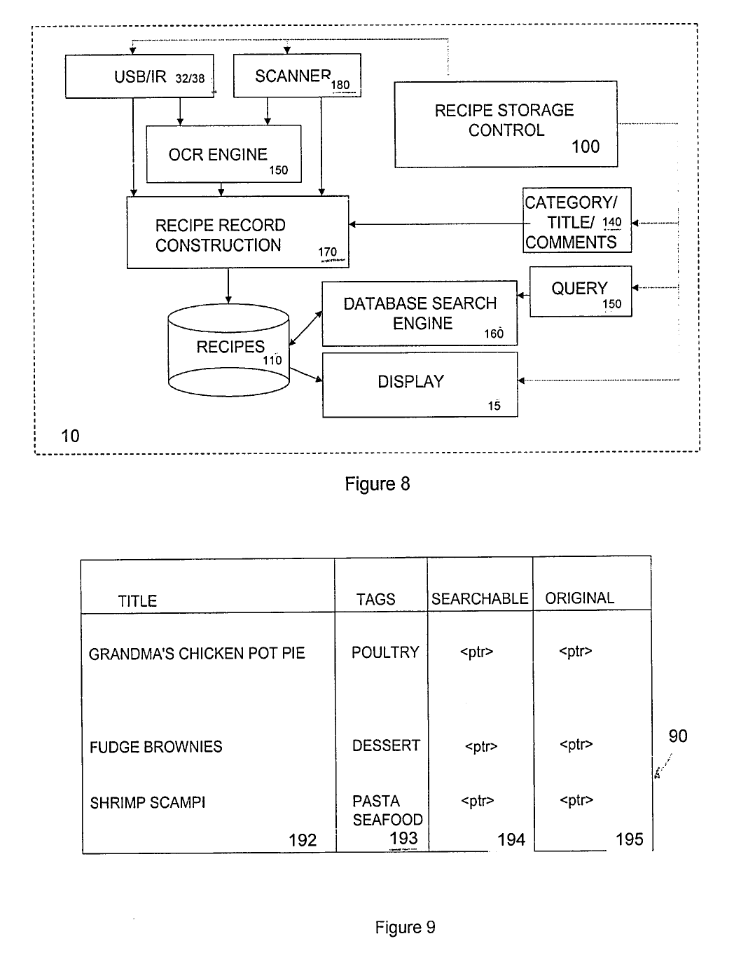

Returning to FIG. 1, the “Search” button 54 can be pressed to perform a keyword search on recipes stored in the recipe storage device 10. When this button is selected, a recipe search screen 79 shown in FIG. 4 is displayed. The recipe search screen includes a soft keyboard, which could also be implemented as a mechanical keyboard that could be detachable or deployable. The user types in a keyword, such as “chocolate” to search for all recipes that contain that word and/or ingredient. The results of the search are displayed on the recipe selection screen 60 shown in FIG. 2 and the device is operated from that point as described above.

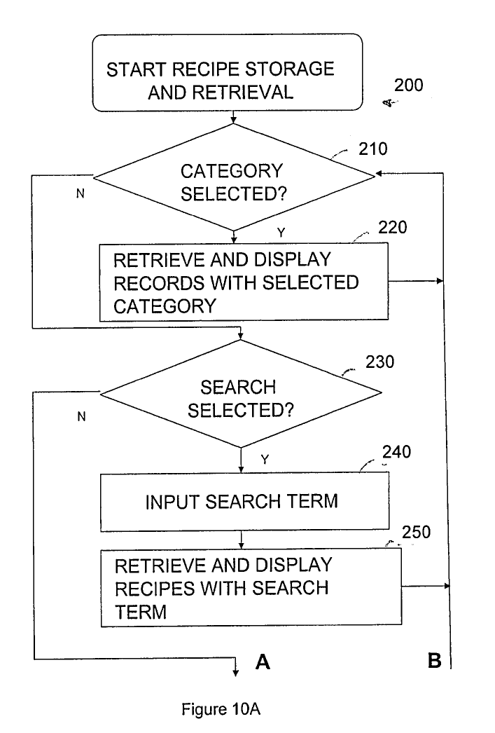

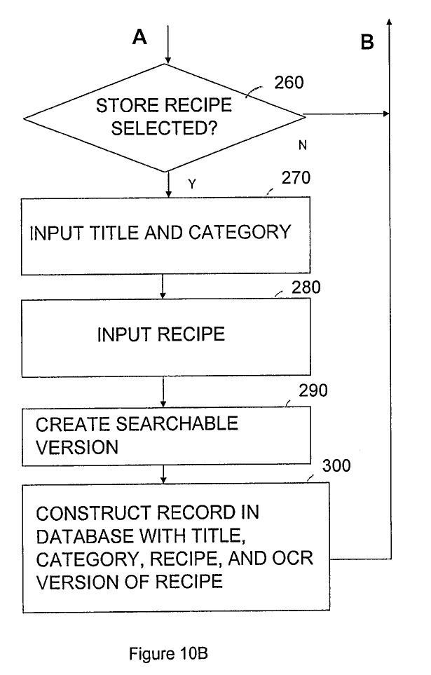

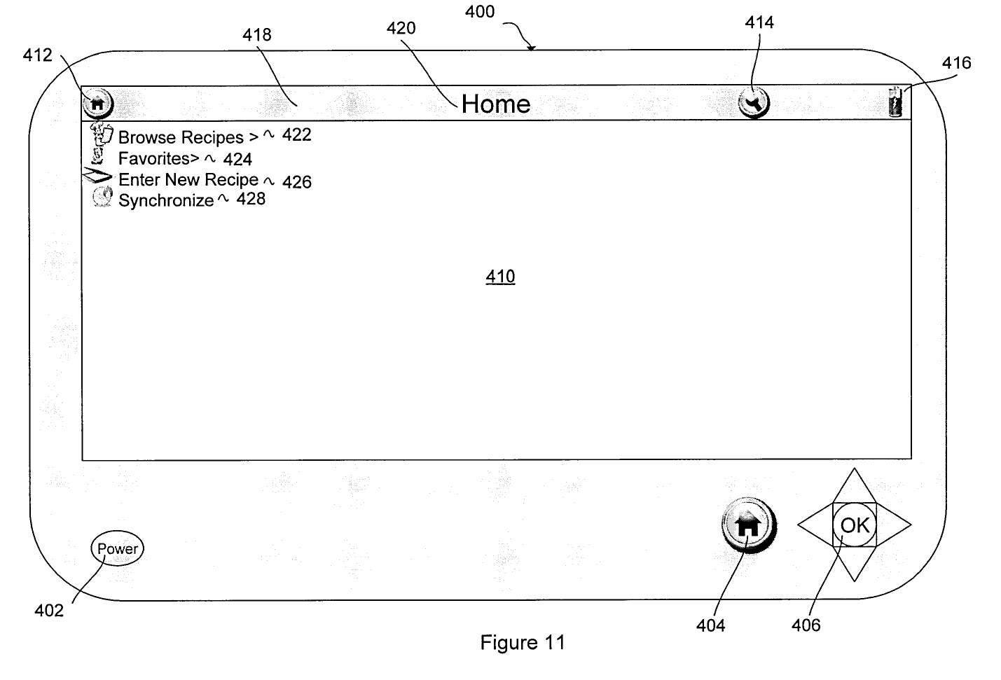

Returning again to FIG. 1, the “Store Recipe” button 56 is selected when the user wants to scan or otherwise input a recipe for storage in the recipe storage device 10. The “Recipe Storage” button takes the user to a recipe title input screen 80 shown in FIG. 5. The user enters the title for the recipe that will be displayed in the recipe selection screen 60 (FIG. 2) for the recipe. After the recipe title is input, recipe category input screen 82 is displayed as shown in FIG. 6. The user selects a category to be associated with the recipe that is about to be input. In one embodiment, the user can select more than one category, for example “Pasta” and “Seafood” may both be associated with a seafood pasta dish. A “No More” button 84 may be selected when the user has entered all of the desired categories. FIG. 7 illustrates a recipe input type selection screen 90 that displays a “Scan Recipe” button 92 and a “Download Recipe” button 94. When the user selects the “Scan Recipe” button, further screens (not shown) guide the user through the steps of passing the recipe through the scanner. Similarly, when the “Download Recipe” button is selected, screens for inputting a recipe in, for example, Microsoft Word® or PDF format, through the USB or IR interface are displayed.

FIG. 8 is a schematic block diagram illustrating functional components of the recipe storage device 10. A microprocessor is shown functionally as recipe storage control 100. The microprocessor executes a recipe storage control algorithm and controls the operation of the scanner and the USB and/or IR ports 32, 38. Of course, some or all of the functions performed by the microprocessor 100 could be performed by a remotely located processor that communicates with the recipe storage device 10 via the USB and/or IR ports 32, 38 or other hardwired or wireless I/O interface. The microprocessor 100 also controls the display 15 to display the screens discussed above and also to receive and process the user's selections.

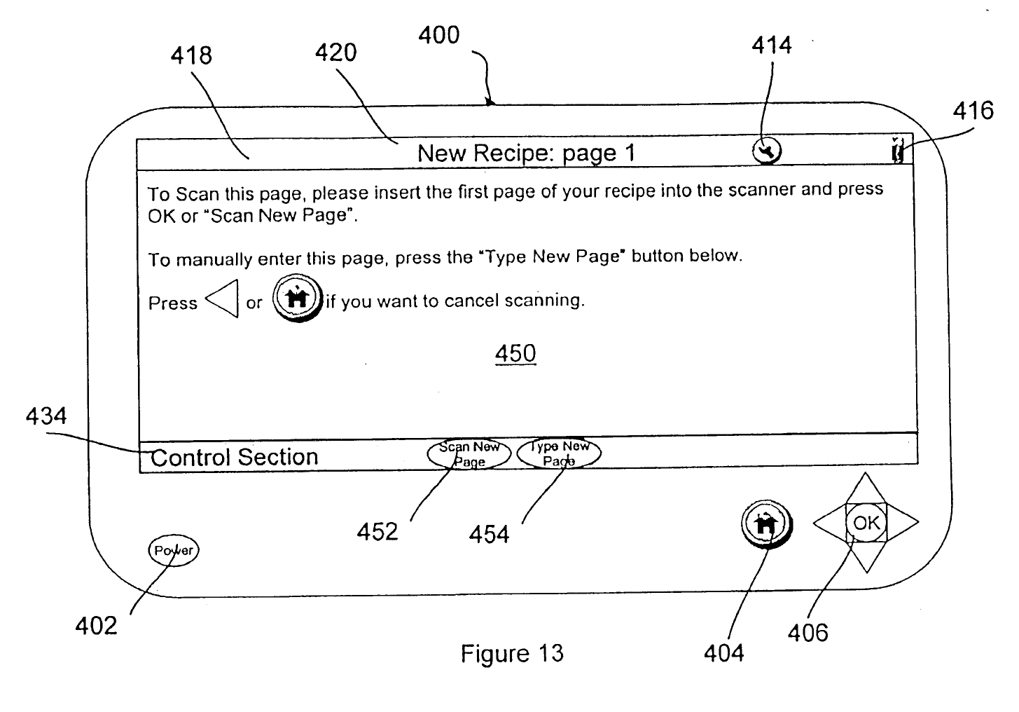

A recipe database 110 is preferably maintained in on board memory but may also be maintained in an SDRAM card or memory stick. The ability to access recipes from an external memory source facilitates sharing of recipes between users by allowing them to copy and trade memory cards or sticks. A recipe record construction module 170 creates recipe records that are stored in the recipe database 110. The recipe record construction module 170 receives input recipes from the scanner 180 and the USB/IR ports 32, 38. The recipe record construction module also receives a searchable version of the input recipe from the OCR engine 150 that processes the input recipe and stores it in a searchable form. It will be apparent that any processing component capable of converting a document into a searchable format can be employed in place of the OCR engine. The recipe record construction module receives additional information 140 from the user about an input recipe, such as the title, category classification, and optional comments that are stored with the recipe. From all of these sources, the recipe record construction module 170 constructs recipe records that are stored in a database, an exemplary portion of which is shown schematically as data table 90 in FIG. 9. The data table 90 includes a title attribute 192 that stores the recipe title. For each title, categories and comments are stored in under a tags attribute 193. Each recipe record also includes a searchable version attribute 194 for storing a memory pointer to the searchable version of the recipe and an original version attribute 195 for storing a memory pointer to the original version of the recipe. Of course, other data structures and arrangements can be employed to create, organize, and search the recipes stored in the recipe storage device 10.

Referring again to FIG. 8, a database search engine 160 is configured to perform keyword searches on the searchable versions of recipes that were created by the OCR engine 150. The search engine 160 processes queries 150 by executing them on the searchable versions of recipes stored in the recipe database 110. These queries can be input by the user or created internally in response to selection of various buttons. The search engine provides the recipes returned by the search to the display 15.

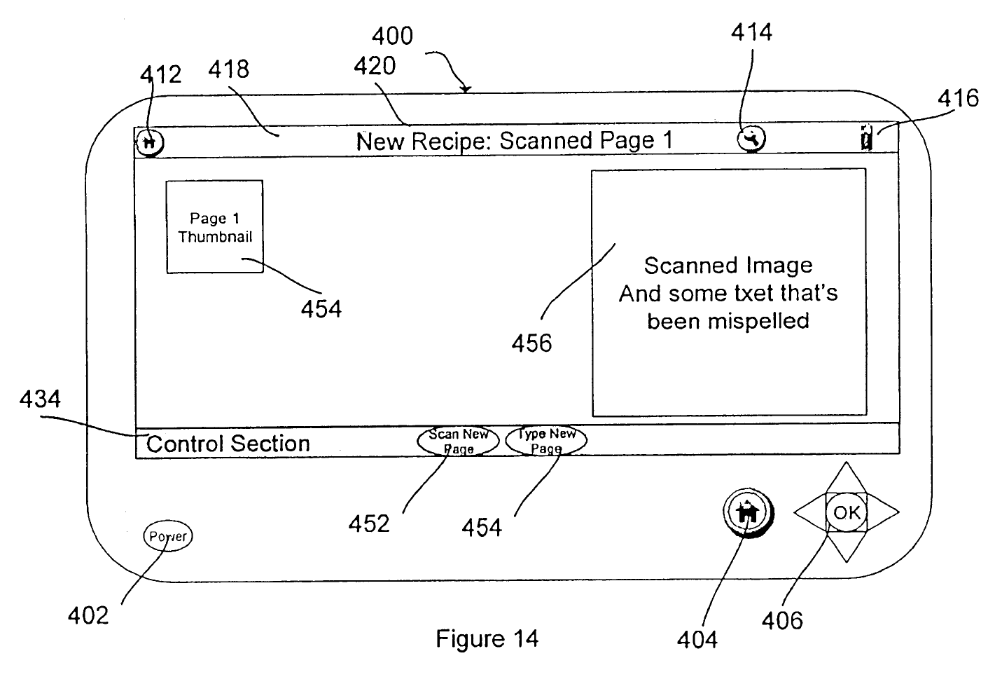

FIGS. 10A and 10B are a flowchart that illustrates a method 200 that can be used in an implementation of the recipe storage device 10. At 210, the method monitors for selection of a category and if one is selected, at 220 recipes in that category are retrieved and displayed, possibly by construction of a proper query for the search engine. If no category has been selected at 230, the method monitors for selection of the search option. When the search option is selected at 240 the method inputs the search term and at 250 the recipes returned by the search are displayed. At 260, the method monitors for selection of the store recipe option. If this option is selected at 270 the title and category are input, at 280 the recipe is input, and at 290 a searchable version of tile recipe is created. At 300 a recipe record is constructed for storage in the recipe database. The recipe record includes the title, category, and the original and searchable versions of the recipe.

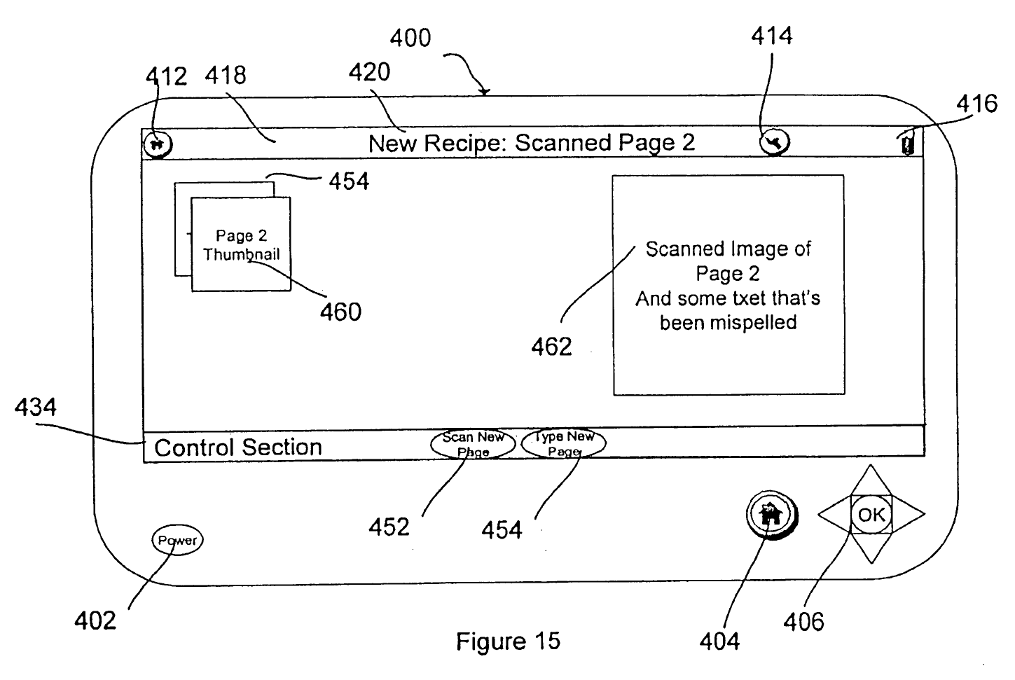

Referring to FIG. 11, another embodiment of an electronic recipe storage device 400 is illustrated. Unless otherwise stated, the device 400 is essentially the same as device 10 discussed above. The device 400 includes a “Power” button 402, an optional “Home” menu button 404, and an optional user input device 406 (e.g., a cursor pad, arrow keys, etc.). The menu button 404 and user input device 406 may be mechanical switches and/or capacitive sensors.

In addition, the electronic storage device 400 includes a graphical user interface screen 410. The user interface screen 410 illustrates a “Home” menu. The “Home” menu is the first menu screen shown when the device 400 is powered on by “Power” button 402 and/or when the “Home” button 404 is actuated. The “Home” screen 410 features a plurality of icons “soft” buttons 412, 414, 416 that are actuated by touching and depressing a corresponding face on the display with a stylus (or other pointing device) and/or manipulating a cursor with the optional user input device 406. The icons 412, 414 and 416 may be positioned on a status bar 418. The status bar 418 includes a title 420 that identifies the current menu position of the display in the menu structure, as discussed below.

The size, location, appearance, and function for all soft buttons and menus are determined by operating software and can be changed by modifying the software. In the particular embodiment shown in FIG. 11, the “Home” menu screen 410 includes three (3) soft function icons (a soft home menu icon 412, a settings tool icon 414, and a battery status icon 416). In addition, the “Home” menu screen 410 includes icons and text that displayed on the main window of screen 410. The icons and text correspond to various functions that may be performed by the portable electronic storage device 400. Such functionality may include browsing recipes, listing favorite recipes, entering a new recipe into the device, and synchronizing the recipe information with another electronic device (e.g., a personal computer). For example, the “Home” menu screen 410 includes icons entitled “Browse Recipes” 422, “Favorites” 424, “Enter New Recipe” 426 and “Synchronize” 428. The number and name of the various icons and text, and as well as any number of recipe storage device operating parameters, can be set by modifying on board software prior to retail. The recipe storage device 400 could also be programmed by a purchaser, possibly using a personal computer communication via the IR interface or USB input port.

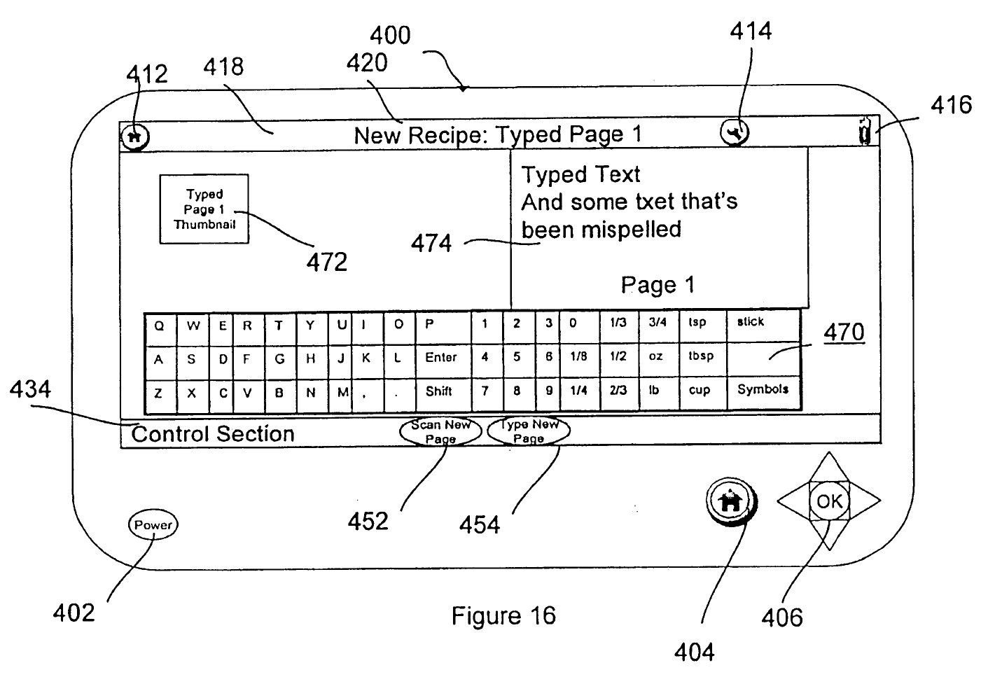

When a user desires to perform one of the functions graphically depicted by one or more of the icons on the “Home” menu 410, the user simply touches and de-presses the screen with a stylus (or other pointing device) and the selected function is initiated. For example, if the user selects “Browse Recipes”, a multi-level folder hierarchy may be presented to the user, as shown in FIG. 12. Such a folder hierarchy is commonly referred to as a “tree” of folders. The “Browse Recipe” screen may illustrate a menu structure in folder window 430 and recipes that correspond to the selected menu may be illustrated in recipe window 432. As shown in menu window 430, the user is provided a multi-level hierarchy of menus to browse for the item of interest. For example, the user may select the “Breads & Pastas” folder, which expands to include sub-folders entitled “Dough”, “Pastas & Noodles”, “Pizza” and “Rolls”. If the user selects “Dough” another sub-folder may be presented to the user if there are additional categories of “Dough” stored in the recipe database 110. As shown in FIG. 12, there are no additional sub-folders categorized under “Dough”. Therefore, any corresponding recipes in the form of electronic files that have been categorized under “Breads & Pastas” and “Dough” (e.g., recipe files 422) may be presented to the user. In one embodiment, the recipes are stored by unique names that are entered by the user. For example, “Multigrain Dough”, “Challah Dough”, “Sourdough” and “Baguette Dough”, as shown in FIG. 12.

As shown in FIG. 12, folder window 430 illustrates a tree structure. In such an environment, the user may be provided conventional folder options, such as create, delete and edit names of folders; rename recipes stored as filenames; create shortcuts to recipes in multiple folders. In addition, it may desirable to track usage of recipes and store such recipes in a folder. For example, recipes may be grouped into meals (e.g., includes folders for “Breakfast”, “Lunch” and “Dinner”). A meal is an ordered list of recipes. In another embodiment, it may desirable to track most recently used recipes (e.g., include a folder for “Recently Used” recipes).

The user may be given the option to “Create” new recipes by selecting the “Create” soft key 435 or “Rename” an existing recipe by selecting the “Rename” soft key 436, which is illustrated in the “Control Section” 434. The “Create” soft key 435 can be used to create a folder or may be a link to “Enter a New Recipe Manually” depending on the context currently selected. The “Rename” soft key 436 enables a user to rename and/or delete a recipe depending the context currently selected. Such functionality may be provided for creating meals, wherein one more recipes and/or links to the recipes may be stored in a folder.

In addition, upon selecting a file it may desirable to present a preview of the selected recipe to the user prior to opening the recipe file. Such a mechanism will enable a user to quickly and efficiently browse recipes if the user is unsure of the desired recipe file.

The status bar 418 identifies the current folder opened by the user. For example, as shown in FIG. 12, the status bar 418 includes the title 420 “Browse Recipes/Breads & Pastas/Dough”, which informs the user that he or she is performing the function of browsing recipes and has navigated to the “Dough” sub-folder under “Recipes” and “Breads & Pastas”.

Due to the hierarchical folder-structure of the graphical user interface described herein, the user is provided flexibility to re-arrange (or re-structure) the tree according to the user's own preferences. This can be done by simply dragging and dropping a folder to the desired hierarchical location. A node of the tree may be expanded to show its children by touching node. Likewise, when the parent of node is touched, the node collapses, as is conventional.

In addition, the user may copy and/or link multiple recipes in multiple categories, which can be done by dragging and dropping a selected icon that corresponds to a recipe (or copying and pasting the selected recipe in multiple folders. In one embodiment, all of the recipes are listed in the “All” folder in window 430 and shortcuts or links are provided to additional references of the recipe in multiple menus (or folders). In another embodiment, each recipe may include metadata in the form of keywords that may be used to categorize the recipe file. In yet another embodiment, after the recipe title and/or filename is input, a recipe category input screen may be displayed as discussed above and the user may select one or more categories to be associated with the recipe that is about to be input.

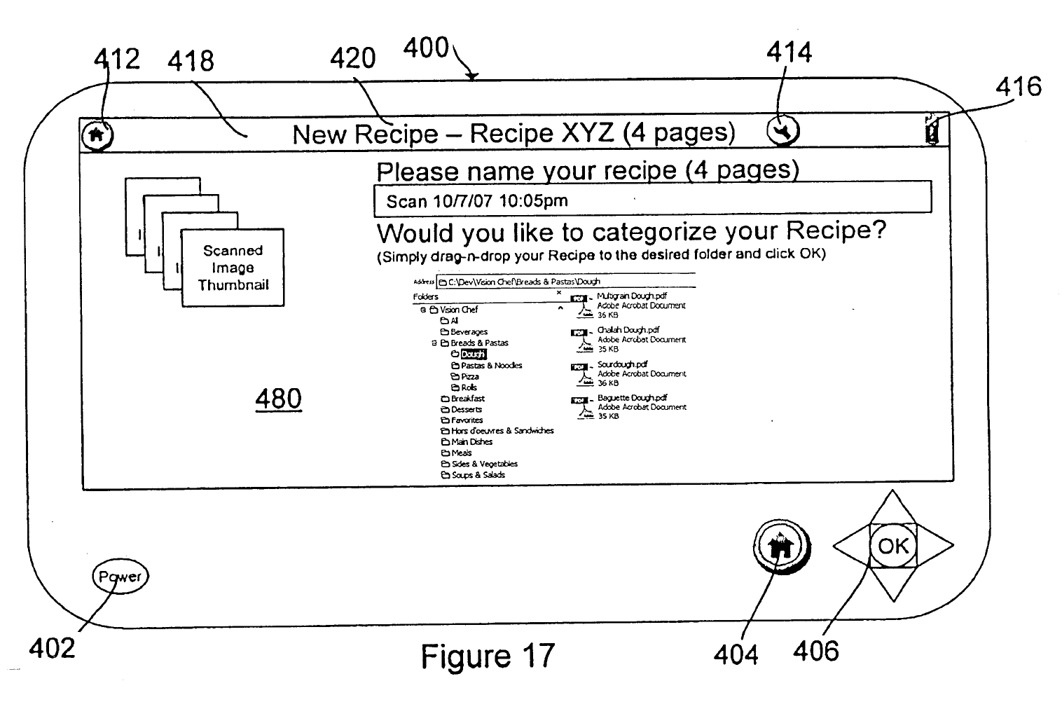

Referring to FIGS. 13-17 another exemplary method for storing new recipes in the recipe storage device 400 is illustrated. Upon selecting “Enter New Recipe” 426 (FIG. 11), a dialog screen 450 appears on the display to provide instructions for the user to enter the new recipe in the recipe storage device. For example, the user may scan a page from a medium by selecting “Scan New Page” soft key 452 or enter the recipe manually by selecting “Type New Page” soft key 454.

Referring to FIG. 14, if the user selects “Scan New Page” soft key 432, the first page of the recipe may be scanned by the scanner 180. A thumbnail 454 of the scanned page may be displayed. In addition, a larger representation of the scanned image 456 may also be displayed so that the user may read the scanned image. If the if the user decides to scan a second page by selecting “Scan New Page” soft key 452, the second page of the recipe may be scanned by the scanner 180. A thumbnail 460 of the second scanned page may be displayed partially over the thumbnail 454 associated with the first page, as shown in FIG. 15. A larger representation of the second page of scanned image 462 may also be displayed so that the user may read the image most recently scanned. The user may select any page of the recipe by selecting a thumbnail associated with the desired recipe page to be viewed.

Referring back to FIG. 13, if the user selects the “Type New Page” soft key 454, a soft keyboard 470 (FIG. 16) is displayed on the display and the user may type the recipe manually into the device. Referring to FIG. 16, as the user types the recipe to be entered, the information may be shown in thumbnail 472 of the typed recipe, as well as a larger representation of the type image 474 so that the user may read and edit the recipe.

Once the user has completed entry of the recipe by either scanning the recipe or entering the recipe manually, the user may be provided a query screen 480 for entering the title for the recipe that will be displayed as the recipe name and the recipe filename. As a default, if the user does not enter a unique recipe name, the date and time that the recipe was entered in the device may be used as the default name for the recipe. After the recipe title is input, the user may select one or more categories to be associated with the recipe that is about to be input, as shown in FIG. 17. For example, the user may select one or more folders and pressing “OK” on the user input device 406. The recipe may be stored in desired file format. For example, the recipes may be stored in JPEG, PDF, TIFF, plain text, a text-searchable format, etc. The recipes (and meals) may also indexed by a text search engine discussed above, so that the recipes (and meals) may be searched by ingredients, as well as by filename.

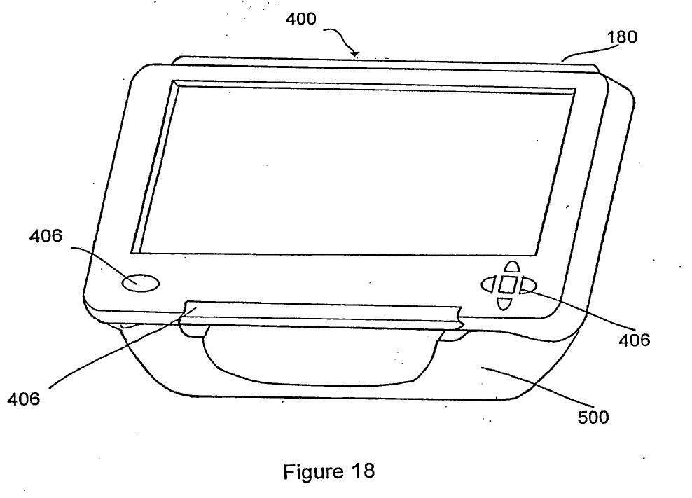

As stated above, the electronic storage device 400 may include a scanner 180 that includes a slot for receiving the recipe medium, as shown in FIG. 1. In another embodiment, the scanner 180 may be provided on a side surface of the recipe storage device. For example, as shown in FIGS. 18 and 19, the scanner may be provided in a top portion of the recipe storage device 400. As such, the user manually directs scanner over the medium to be scanned. For example, if the recipe is in a cookbook, the user simply activates the electronic storage device 400 selects the appropriate new recipe screen (e.g., “Scan Recipe” (FIG. 7), “Enter New Recipe” (FIG. 11)) and directs the scanner perpendicular to the new recipe and manually traverses the scanner horizontally over the recipe. In such embodiments, it may be desirable to include a grip portion 485 to allow the user to easily grasp and hold the device 400 during the scanning process. Such a scanner facilitates scanning recipes in cookbooks, magazines and the like without tearing the pages out of the book containing the recipe.

The scanner may be any desired size. In one embodiment, the scanner is sized to scan a medium (e.g., a page of a book, a standard 8.5 inch width sheet of paper. In another embodiment, the scanning unit may have a width less the 8.5 inches. In such instances, it may be desirable to include scanner registration software to correct for overlapping scan passages over the same portion of the scanned recipe.

In yet another embodiment, a scanning unit 502 may be integrated in a docking station or cradle 500 that receives the electronic storage device, as shown in FIG. 19. The scanning unit 502 may be in addition to a scanner 180 integrally housed in the electronic storage device 400. As such, the scanner 502 may be a mechanical feed scanner, which may require less processing than other types of scanners. Alternatively, electronic storage device 400 may include a bar scanner that allows the user to manually scan recipes and the docking station 500 may include a mechanical feed scanner 502 that allows pages of recipes to be scanned and stored in the device 400 and/or an associated computer coupled to the scanner. The scanner 180, 502 may also be a wand scanner that is secured to the housing of the electronic storage device 400 or the docking station 500 through a cable, respectively. The scanner 502 may be positioned in any desired location of the docking station 500. Likewise, the scanner 502 may store scanned recipes directly to the device 10, 400 and/or store the recipe information directly to a personal computer, as discussed below.

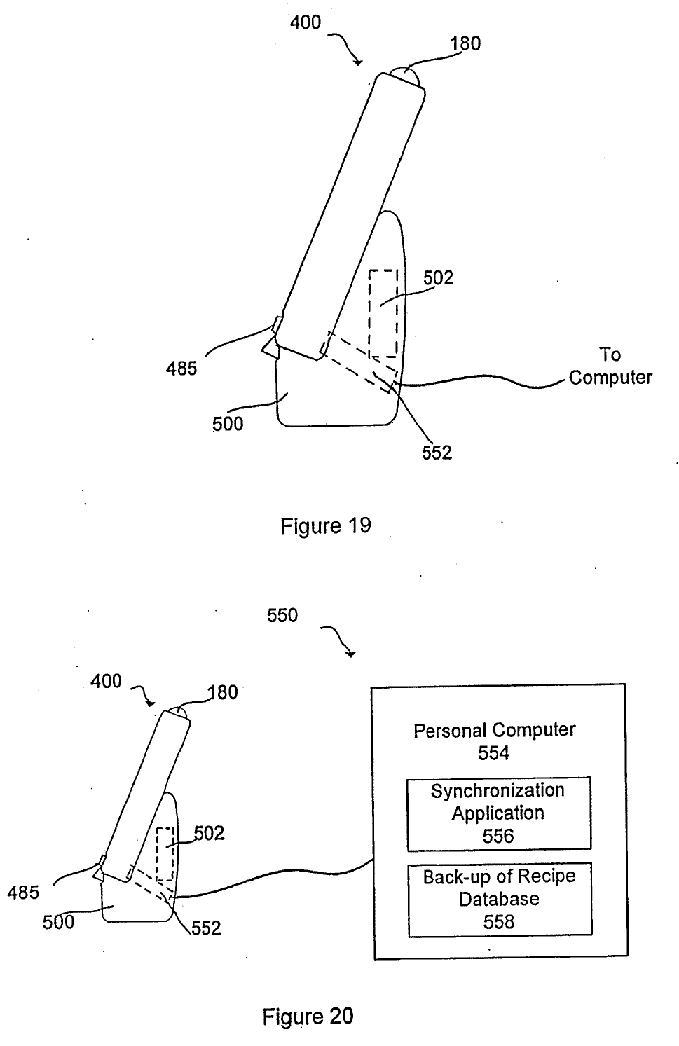

Referring to FIG. 20, a exemplary storage and retrieval system 550 is illustrated. The system 550 includes a docking station 500 and a portable electronic recipe storage device 10, 400. The docking station 500 includes a communication port 552 (e.g., a USB port) for exchanging communication signals between the portable electronic recipe storage unit and an associated computer 554. The docking station 500 may also serve to charge the portable electronic storage unit 10, 400 through the communication port 552. The docking station 500 may include a scanner 502 housed at least partially within the docking station for scanning recipes. As discussed above, the scanner 502 may by any type of scanning. Since the scanning unit 502 forms a portion of the docking station 500, a mechanical feed scanner or wand scanner may be used. The docking station 500 may also include one or more mechanical engagement structures (not shown) to secure the portable electronic storage device 10, 400 in the docking station.

The system 550 further includes a personal computer 554 that is communicatively coupled to the portable electronic recipe storage device through the communication port of the docking station. The computer 554 includes a synchronization application 556 to back-up and store recipes stored in the electronic recipe storage device on a hard drive associated with the computer 554. In addition, recipes scanned by the scanning unit 502 contained in the docking station 500 and/or manually entered by a user at the personal computer 554 may be synchronized by transferring such recipes to the electronic storage device 10, 400. Likewise, the personal computer 554 may serve as a back-up to the electronic storage device 10, 400. For example, when connected to docking station 500, the recipes stored in the electronic storage device 10, 400 may be transferred to the personal computer automatically upon connecting the electronic storage device to the docking station, assuming the docking station is coupled to the computer 554. Alternatively, the user may manually initiate transfer of one or more recipes from the device to the computer and/or from the computer to the device.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adapt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

1. A portable electronic recipe storage device comprising:
a housing suitable to be supported in an associated user's hand;
a display secured at least partially within the housing, wherein the display presents recipe information to the associated user in a graphical user interface;
a scanner secured to the housing, wherein the scanner receives recipe information from a medium;
a memory for storing the recipe information, wherein the memory is secured in the housing; and
a processor coupled to the display, the scanner and the memory, wherein the processor is configured to receive recipe information from the scanner, store the recipe information in the memory and display the recipe information to the associate user.

2. The portable electronic recipe storage device of claim 1, wherein the memory includes at least one scanned recipe and a text searchable version of the scanned recipe.

3. The portable electronic recipe storage device of claim 2, wherein the memory includes at least one searchable database for storing text searchable versions of recipes.

4. The portable electronic recipe storage device of claim 1, wherein the memory includes at least one database for storing original versions of recipes.

5. The portable electronic recipe storage device of claim 1, wherein the display is a touch screen.

6. The portable electronic recipe storage device of claim 1, wherein the scanner is a scanner type selected from a group consisting of a hand scanner, a bar scanner, a sheet-fed scanner or flat bed scanner.

7. The portable electronic recipe storage device of claim 1 further including a communication port coupled to the microprocessor, wherein recipe information may be exchanged with other electronic devices coupled to the communication port.

8. The portable electronic recipe device of claim 1, wherein the graphical user interface is a hierarchical folder-based user interface.

9. The portable electronic recipe storage device of claim 1 further including a user input device coupled to the microprocessor, wherein the user input device is operable by an associated user to interact with the graphical user interface.

10. The portable electronic recipe storage device of claim 1, wherein the user input device is a cursor pad.

11. The portable electronic recipe storage device of claim 1 further including a securing means for removably securing the device to an associated structure.

12. The portable electronic recipe storage device of claim 11, wherein the securing means is a magnet.

13. The portable electronic recipe storage device of claim 1 further including a battery secured in the housing for providing power to the device.

14. The portable electronic recipe storage device of claim 13, wherein the battery is a rechargeable batter.

15. A method for storing recipe information, the method comprising:
scanning a medium containing a recipe;
storing the recipe in a memory, wherein the recipe is stored in an original form and in a text searchable form;
querying an associated user through a graphical user interface on a display to assign a recipe name to the recipe;
receiving a user input indicative of a response to the query, wherein the user input includes the unique recipe name; and
assigning the unique name to the recipe.

16. The method of claim 15, wherein the recipe name is an unique name.

17. The method of claim 15 further including assigning the recipe to a recipe category, wherein the recipe includes at least item characterized by the recipe category.

18. The method of claim 15 further including generating an icon representative of the unique name in the graphical user interface and displaying the icon in the graphical user interface.

19. The method of claim 18 further including manipulating the icon with a user input device to move and/or link the icon to a desired recipe category.

20. The method of claim 19, wherein the desired recipe category is represented in the graphical user interface by an electronic folder presented on the display.

21. The method of claim 15 further including storing a plurality of recipes, wherein each of the of recipes include one or more recipe categories as a meal, wherein the each of the recipes may be used to make a portion of the meal.

22. The method of claim 15 further including providing a soft keyboard in the graphical user interface for the associated user to enter information associated with the recipe in the graphical user interface.

23. The method of claim 15 further including storing the recipe in the original form in a database.

24. The method of claim 23 further including storing the text searchable form of the recipe in the database.

25. The method of claim 24 further including linking the stored recipe in the original form to the text searchable form of the recipe.

26. A method for retrieving recipe information, the method comprising:
displaying a plurality of icons on a graphical user interface, wherein each of the plurality of icons is associated with a unique function;
receiving an indication from an associated user of a desire to retrieve recipe information;
querying the associated user to enter a target recipe to be found in a database of recipes;
searching the database of recipes to find the target recipe; and
displaying the target recipe in a first form, wherein the first form is a scanned form of the original recipe.

27. The method of claim 25 further including displaying the target recipe in a second form, wherein the second form is a text searchable form of the original recipe.

28. A recipe storage and retrieval system, the system comprising: the portable electronic recipe storage device of claim 1; and
a docking station having at least one engagement surface for holding the portable electronic recipe storage device, wherein the docking station includes a communication port for exchanging communication signals between the portable electronic recipe storage unit and an associated computer; and the docking station includes a scanner housed at least partially within the docking station.

29. The system of claim 28, wherein the scanner housed at least partially within the docking station is a mechanical feed scanner.

30. The system of claim 28 further including a personal computer coupled to the portable electronic recipe storage device through the communication port of the docking station.

31. The system of claim 30 wherein the personal computer includes a memory for storing recipe information received from the scanner housed at least partially within the docking unit.

32. The system of claim 31, wherein the personal computer includes a synchronization application stored in the memory for synchronizing recipe information on the portable electronic recipe organizer and the personal computer.
